(19) United States
(12) Patent Application Publication
(10) Pub. No.: US 2007/0018016 A1
(43) Pub. Date: Jan. 25, 2007

(54) Liquid spraying assembly

(76) Inventor: Simon Yechouron, Montreal (CA)

Correspondence Address: Louis Tessier, P.O. Box 54029, Town of Mount Royal, QC, H3P 3H4, CA

(21) Appl. No.: 11/488,850

(22) Filed: Jul. 19, 2006

Related U.S. Application Data
(60) Provisional application No. 60/700,313, filed on Jul. 19, 2005.

(51) Int. Cl. A01G 25/14

(52) U.S. Cl. 239/376; 239/327; 239/372

(57) ABSTRACT

A spraying assembly for spraying a liquid. The spraying assembly includes a reservoir for containing the liquid, the reservoir defining a reservoir outlet; a venting tube defining a tube inlet, a tube outlet substantially opposed to the tube inlet and a tube passageway extending therebetween, the tube inlet being positioned within the reservoir; and a spray gun for spraying the fluid, the spray gun including a gun inlet couplable to the reservoir outlet so as to allow the liquid to flow from the reservoir into the spray gun. The tube outlet is in fluid communication with the exterior of the reservoir, thereby allowing venting the reservoir such as to reduce a vacuum created when the liquid flows out from said reservoir through the reservoir outlet.

This application claims priority from U.S. Provisional Patent Application Ser. No. 601700,313 filed Jul. 19, 2005.

### FIELD OF THE INVENTION

The present invention relates to the general field of spray guns and is particularly concerned with a liquid spraying assembly.

### BACKGROUND OF THE INVENTION

In many industries, such as for example in the automotive collision repair industry, there is often a need to spray a liquid, such as paint, on only part of an object using a spray gun. Since the object, for example a car, is often already at least in part painted, a painter needs to insure that the newly painted portions are of substantially the same color as the already painted portions of the object. This process is known in the art as color matching.

Typically, paint of an approximately suitable color is mixed according to a predetermined recipe to produce a first paint. Then, part of the object to be painted is sprayed with this first paint and the resulting color is compared to the color of a portion of the object that is already painted. This allows an intended user to adjust the composition of the first paint so that the color of the newly painted portion is substantially identical to the color of the already painted portions.

However, this process is relatively time consuming as there is a need to attach a paint container into which the first paint is contained to the spray gun each time that a color match test is required. Furthermore, typically, paints are applied in many coatings. Therefore, the attachment/detachment steps are typically performed many times for each paint job.

A solution for this problem that has been proposed is to use a separate, smaller liquid supply assembly to supply the paint for color matching and to use thereafter a larger liquid supply assembly to supply the paint during the painting process per se. However, this solution requires that additional material that must be bought by the painter and is relatively environmentally unfriendly as the smaller container is typically disposable.

In another prior art liquid supply assembly 10, as shown in FIG. 1, a paint reservoir 16 is typically secured to a spray gun 12 through an internally threaded neck 14 of the reservoir 16. To that effect, the gun 12 includes an externally threaded reservoir receiving portion 17.

The liquid supply assembly 10 includes a removable cover 18 that is threaded onto the reservoir 16. The cover 18 allows changing the composition of the paint within the reservoir 16 by unthreading the cover 18 from the reservoir 16, adding into the reservoir 16 suitable paint components, and subsequently threading the cover 18 onto the reservoir 16. However, this operation is relatively time-consuming and relatively hard to perform without spilling the paint as the reservoir remains attached to the spray gun 12, which is relatively cumbersome to handle.

Also, it is relatively hard to mix the paint in the reservoir 16 to achieve a relatively homogeneous mixed paint. Accordingly, users of the liquid supply assembly 10 typically pour the paint out of the reservoir 16 into another container, mix the paint in this container and pour the mixed paint back in the reservoir 16. Once again, this operation is relatively time-consuming.

As shown in FIG. 2, in an alternative prior art liquid supply assembly 10′, an alternative cover 18′ is secured to an alternative reservoir 16′ through a friction fit. While this allows for a relatively fast and easy removal and attachment of the cover 18′ from and to the reservoir 16′, the liquid supply assembly 10′ does not solve the problems of having to thread and unthread the reservoir 16′ to and from the spray gun 12 and of being relatively time-consuming in changing the composition of the paint.

In another prior art liquid supply assembly, shown in FIG. 3, another alternative paint reservoir 16″ is usable as a mixing container for mixing the paint prior to spraying with a spray gun. The reservoir 16″ includes a bottom wall 22 and a peripheral wall 24 extending substantially outwardly therefrom. The peripheral wall 24 includes a threaded rim 26 defining an aperture 28.

A removable cover 30 is provided for blocking the aperture 28, the removable cover 30 including an outlet 32. The outlet 32 is used to provide paint to a spray gun (not shown in FIG. 3).

Since the reservoir 16″ is typically relatively rigid, there is a need to provide an air vent 34, for example in the bottom wall 22, to allow air to flow into the reservoir 16″ when the reservoir 16″ supplies paint to a spray gun. A removable plug 36 is provided for selectively blocking and unblocking the air vent 34. More specifically, when the reservoir 16″ is used to mix paint, the plug 36 is inserted into the air vent 34 so that paint does not flow out from the reservoir 16″ from the air vent 34.

When the reservoir 16″ provides paint, the bottom wall 22 is above the outlet 32. This allows removing the plug 36 from the air vent 34 to allow air to come into the reservoir 16″, thereby minimizing a low pressure that may be formed in the reservoir 16″ as a result of paint exiting a container having a single outlet 32.

A first disadvantage of this prior art reservoir 16″ is that the plug 36 is a relatively small component that is relatively easily lost or misplaced. Also, adding and removing the plug 36 from the air vent 34 adds additional steps that need to be remembered and that are relatively time-consuming.

In addition, there is a risk that while in use, the spray gun is oriented so that paint may flow out of the reservoir 16″ through the air vent 34 and fall onto the object to be painted.

Against this background, there exists a need in the industry to provide an improved liquid spraying assembly.

An object of the present invention is therefore to provide an improved liquid spraying assembly.

### SUMMARY OF THE INVENTION

In a first broad aspect, the invention provides a spraying assembly for spraying a liquid. The spraying assembly includes a reservoir for containing the liquid, the reservoir defining a reservoir outlet; a venting tube defining a tube inlet, a tube outlet substantially opposed to the tube inlet and a tube passageway extending therebetween, the tube inlet being positioned within the reservoir; and a spray gun for spraying the fluid, the spray gun including a gun inlet couplable to the reservoir outlet so as to allow the liquid to flow from the reservoir into the spray gun. The tube outlet is in fluid communication with the exterior of the reservoir, thereby allowing venting the reservoir such as to reduce a vacuum created when the liquid flows out from said reservoir through the reservoir outlet.

In a variant, the reservoir includes a reservoir end wall, a reservoir peripheral wall extending therefrom and a reservoir lid extending from the reservoir peripheral wall substantially opposed to said reservoir end wall. The reservoir outlet is a lid outlet defined in the reservoir lid. The tube extends in a direction leading substantially away from the reservoir end wall such that the tube outlet is positioned further away from said reservoir end wall than the tube inlet. In some embodiments of the invention, the tube inlet is positioned substantially adjacent the reservoir end wall.

However, in other variants, the reservoir takes any other suitable form. For example, the reservoir is a reservoir sold with the liquid contained thereinto. In this case, in some embodiments of the invention, there is no need to have a reservoir lid.

Advantageously, the venting tube allows admitting air into the reservoir while the liquid is supplied to the spray gun so as to allow the liquid to flow into the gun inlet. Because of its configuration, the venting tube allows to admit this air while substantially preventing the risk that the liquid be spilled out of the reservoir when the gun is moved such that the reservoir is not completely vertical.

In addition, the reservoir is relatively easily removable from the gun as there is no need to then add a cap or any other object to the tube used for venting. Indeed, when an intended user wishes to remove the reservoir from the spray gun, the intended user only orients the reservoir so that the spout points substantially upwardly and detaches the reservoir from the gun. There is no need to add any other component to the reservoir to prevent the paint from spilling.

In addition, the reservoir and other components of the spraying assembly are relatively easily manufactured at relatively low costs. Also, the spraying assembly is relatively easily used and may be manipulated using relatively simple and ergonomic steps.

In some embodiments of the invention, the reservoir may be engaged with the spray gun temporarily to spray a relatively small volume of the liquid contained in the reservoir, for example when colour matching paint. When it is desired to spray a larger volume of the liquid, a reservoir attachment may be used to attach the reservoir to the spray gun so that the spray gun may be operated using a single hand.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, already described, in a side elevation view, illustrates a prior art reservoir secured to a spray gun;

FIG. 2, already described, in a side elevation view, illustrates an alternative prior art reservoir secured to a spray gun;

FIG. 3, already described, in a cross sectional view, illustrates another alternative prior art reservoir;

FIG. 4, in a side cross sectional view, illustrates a liquid spraying assembly in accordance with an embodiment of the present invention, the liquid spraying assembly including a reservoir, a lid, a reservoir attachment and a spray gun;

FIG. 5, in a partial exploded perspective view, illustrates a liquid spraying assembly in accordance with an alternative embodiment of the present invention;

FIG. 6, in a partial cross-sectional view, illustrates a liquid spraying assembly in accordance with another alternative embodiment of the present invention;

FIG. 7, in a perspective view, illustrates a liquid spraying assembly in accordance with yet another alternative embodiment of the present invention;

FIG. 8, in an alternative perspective view, illustrates the reservoir of FIG. 4.

FIG. 9, in a perspective view, illustrates a reservoir attachment for attaching a reservoir to a spray gun in accordance with an alternative embodiment of the present invention;

FIG. 10a, in a perspective cross sectional view, illustrates a lid spout usable with the reservoir lid of FIG. 1;

FIG. 10b, in a perspective cross sectional view, illustrates an alternative lid spout usable with the reservoir lid of FIG. 1;

FIG. 10c, in a perspective cross sectional view, illustrates another alternative lid spout usable with the reservoir lid of FIG. 1;

FIG. 10d, in a perspective cross sectional view, illustrates yet another alternative lid spout usable with the reservoir lid of FIG. 1;

FIG. 10e, in a perspective cross sectional view, illustrates yet another alternative lid spout usable with the reservoir lid of FIG. 1; and

FIG. 10f, in a perspective cross sectional view, illustrates yet another alternative lid spout usable with the reservoir lid of FIG. 1.

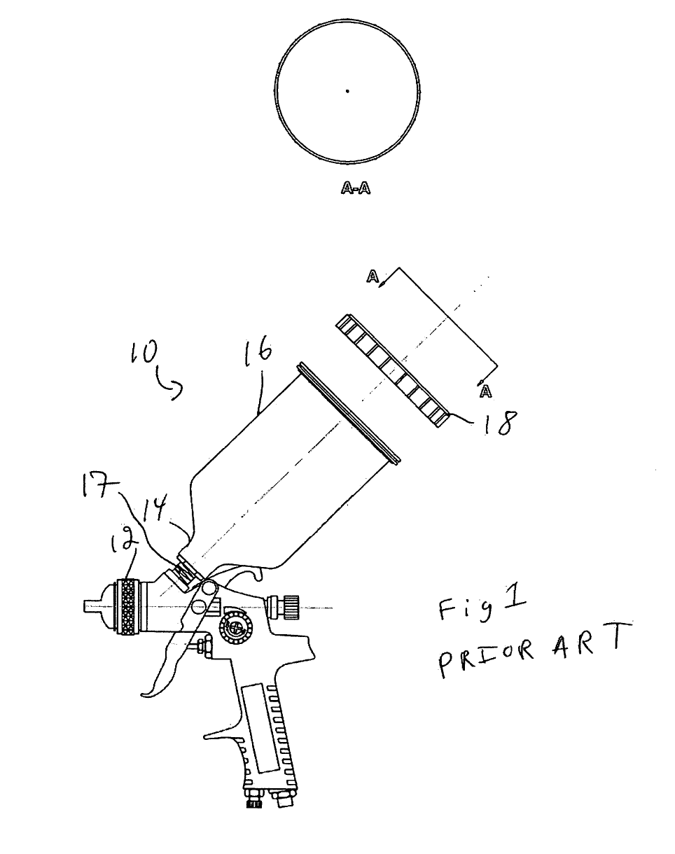

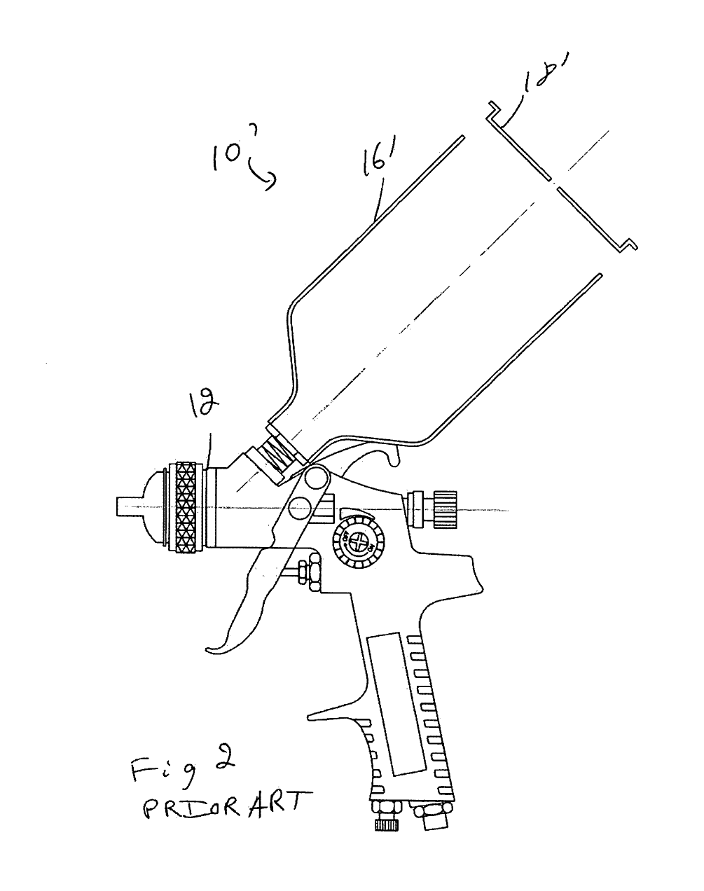

### DETAILED DESCRIPTION

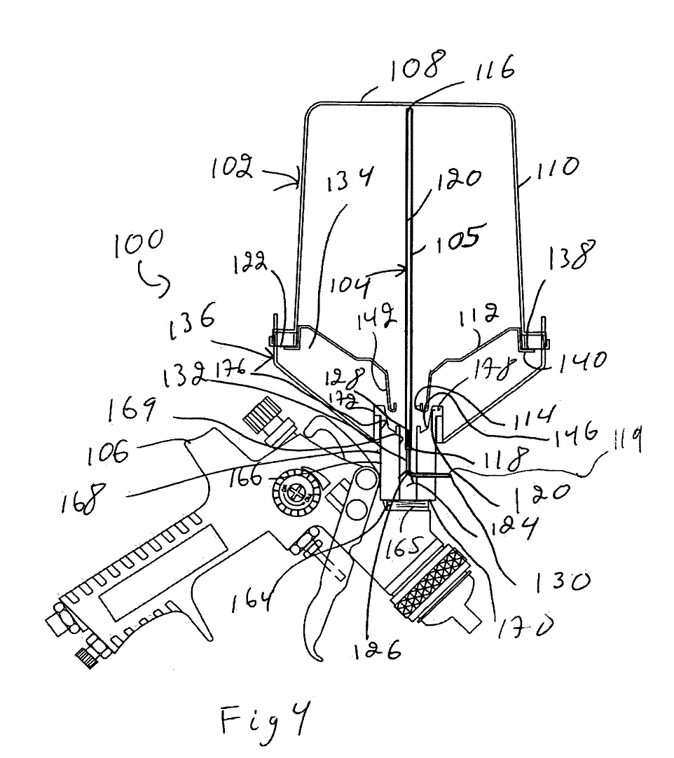

FIG. 4 illustrates a spraying assembly 100 for spraying a liquid (not shown in the drawings). The spraying assembly 100 includes a reservoir 102 for containing the liquid. The spraying assembly 100 also includes a venting tube 104, which extends, at least in part, within the reservoir 102. Furthermore, the spraying assembly 100 includes a spray gun 106 for spraying the fluid. The reservoir 102 includes a reservoir outlet couplable to the spray gun 106 so as to allow the liquid to flow from the reservoir 102 into the spray gun 106.

The venting tube 104 defines a tube inlet 116, a tube outlet 119 substantially opposed to the tube inlet 116 and a tube passageway 120 extending therebetween. The tube inlet 116 is positioned within the reservoir 102 and the tube outlet 119 is in fluid communication with the exterior of the reservoir 102, thereby allowing venting the reservoir 102 such as to reduce a vacuum created when the liquid flows out from the reservoir 102 through the reservoir outlet.

The reservoir 102 includes a reservoir end wall 108, a reservoir peripheral wall 110 extending therefrom and a reservoir lid 112 extending from the reservoir peripheral wall 110 substantially opposed to the reservoir end wall 108. The reservoir lid 112 defines a reservoir outlet in the form of a lid outlet 114. The spray gun 106 includes a gun inlet 120 couplable to the lid outlet 114 so as to allow the liquid to flow from the reservoir 102 into the spray gun 106. However, in alternative embodiments of the invention, the reservoir 102 takes any other suitable form.

In the embodiment of the invention shown in FIG. 4, the tube inlet 116 is positioned within the reservoir 102 substantially adjacent to the reservoir end wall 108. The venting tube 104 extends in a direction leading substantially away from the reservoir end wall 102 such that the tube outlet 119 is positioned further way from the reservoir end wall 102 and the tube inlet 116.

The reservoir peripheral wall 110 defines a reservoir rim 122 located substantially opposed to the reservoir end wall 108. In some embodiments of the invention, the tube outlet 119 is positioned further away from the reservoir end wall 108 than the reservoir rim 122. In other words, the venting tube 104 extends further away from the reservoir end wall 108 than the reservoir peripheral wall 110. However, in alternative embodiments of the invention, the venting tube 104 does not extend further away from the reservoir end wall 108 than the reservoir peripheral wall 110.

The gun inlet 120 defines an inlet passageway 124 for receiving the liquid. In some embodiments of the invention, the venting tube 104 includes a tube first segment 105 and a tube second segment 126 defining a second segment inlet 128, a second segment outlet 130 and a second segment 132 extending therebetween. The tube first segment 105 defines a first segment outlet 118 opposed to the tube inlet 116. The tube second segment 126 extends partially within a portion of the tube passageway 120 defined by the tube first segment 105.

The tube second segment 124 allows securing the tube first segment 104 thereto so as to vent the reservoir 102 from the second segment outlet 130, which is in communication with the atmosphere in which the spray gun 106 is used. To that effect, the tube first segment 105 extends through the lid outlet 114. However, in alternative embodiments of the invention, the tube first segment 105 extends from within the reservoir 102 in any other suitable manner.

The reservoir 102 defines a reservoir aperture 134 extending thereacross substantially opposed the reservoir end wall 108. The reservoir lid 112 is reversibly attachable to the reservoir peripheral wall 110 substantially in register with the reservoir aperture 134. For example, the reservoir lid 112 is configured and sized so as to frictionally engage the reservoir peripheral wall 110 when the reservoir lid 112 is attached to the reservoir 102.

However, in some embodiments of the invention, the reservoir lid 112 is permanently secured or non-reversibly attachable to the reservoir peripheral wall 110. In other embodiments of the invention, the reservoir lid 112 is securable to the reservoir 102 in any other suitable manner.

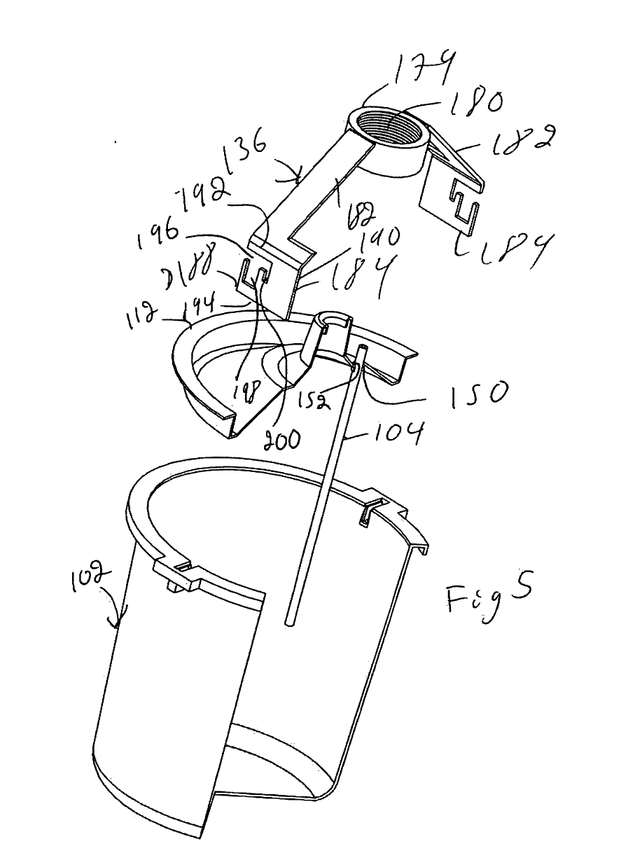

In some embodiments of the invention, a reservoir attachment 136 is provided for attaching the reservoir 102 to the spray gun 106. The reservoir attachment 136 is operable between a locked configuration, as shown in FIG. 4, and an unlocked configuration, as shown in FIG. 5 which illustrates the attachment 136 and an alternative reservoir 102′. In the locked configuration, the reservoir attachment 136 secures the reservoir 102 to the spray gun 106. In the unlocked configuration, the reservoir attachment 136 allows an intended user to uncouple the reservoir 102 from the spray gun 106. The reservoir attachment 136 is described in further details hereinbelow.

In some embodiments of the invention, in the locked configuration, the reservoir attachment 136 biases the reservoir rim 122 and the reservoir lid 112 towards each other. For example, and non-limitingly, the reservoir rim 122 includes a substantially annular and radially outwardly extending rim flange 138. Also, the lid 112 includes a substantially annular lid flange 140 located at the periphery thereof. The lid flange 140 abuts against the rim flange 138 when the reservoir lid 112 is biased towards the reservoir peripheral wall 110.

Advantageously, in some embodiments of the invention, the lid flange 140 and the rim flange 138 are substantially parallel relatively to each other to provide a substantially liquid proof seal between the lid flange 140 and the rim flange 138. In these embodiments of the invention, in the locked configuration, the lid flange 138 is biased against the reservoir flange 140.

A substantially liquid-proof seal may be formed between the reservoir lid 112 and the reservoir 102 and between the reservoir lid 112 and the spray gun 106 in many different manners. For example, in some embodiments of the invention, the reservoir lid includes a lid spout 142 insertable into the gun inlet 120 through a substantially longitudinal movement of the lid spout 142 relatively to the gun inlet 120. Biasing the lid spout 142 towards the gun inlet 120 provides a substantially liquid-proof seal, as described in further details hereinbelow.

In some embodiments of the invention, the reservoir lid 112 is deformable between a compressed configuration and an uncompressed configuration. In the compressed configuration, the lid spout 142 is closer to the container end wall 108 than in the uncompressed configuration. In other words, when passing from the uncompressed configuration to the compressed configuration, the lid spout 142 is moved towards the reservoir end wall 108. The force required to move the lid spout 142 relatively to the reservoir end wall 108 creates a strain in the lid 112 that results in the lid 112 to be biased against the reservoir rim 122.

In some embodiments of the invention, the reservoir lid 112 is substantially resiliently deformable between the compressed configuration and the uncompressed configuration. This may be achieved, for example, by having a reservoir lid 112 that has a substantially radial cross-section including at least two segments angled relatively to each other.

However, in alternative embodiments of the invention, the reservoir lid 112 is not resiliently deformable between the compressed configuration and the uncompressed configuration. In these embodiments, deforming the reservoir lid 112 from the uncompressed configuration to the compressed configuration results in some non-reversible deformation of the reservoir lid 112.

In some embodiments of the invention, the lid spout 142 is substantially tapered in a direction leading substantially away from the reservoir end wall 108. Similarly, the gun inlet 120 defines a gun inner surface 146, the gun inner surface 146 being tapered in a direction leading substantially away from the reservoir end wall 108. When the lid 112 and the reservoir 102 are attached to the spray gun 106, the lid spout 142 engages the gun inlet inner surface 146 so as to form a substantially liquid-proof seal therebetween.

The venting tube 104 may have any suitable configuration and dimensions. In a specific embodiment of the invention, the tube passageway 120 has a diameter within the interval of from about 0.2 mm to about 5 mm. However, in alternative embodiments of the invention, the tube passageway 120 has any other suitable dimension.

In use, the reservoir 102 is positioned with the reservoir aperture 134 pointing substantially upwardly. The lid 112 is not positioned onto the reservoir 102. Then, the liquid is poured into the reservoir 102. For example, the liquid is a paint that is to be sprayed onto a surface.

In this case, it often occurs that the colour of the paint must be matched to the colour of paint already present on some portions of the surface to be painted. It is therefore required that the paint be tested onto the surface to make sure that the colour of the paint to be sprayed is substantially similar to the colour of the paint already present on the surface.

In these embodiments, the spraying assembly 100 may be used as follows. The venting tube 104 is inserted onto the venting member 126. Then, the lid 112 is positioned onto the reservoir 102 and secured to the reservoir peripheral wall 110.

The spray gun 106 is oriented such that the gun inlet 120 faces substantially downwardly. Then the spray gun 106 is moved such that the lid spout 142 engages the gun inlet 120. The reservoir 102 may then be biased manually towards the spray gun 106. In this case, the reservoir attachment 136 is not required. Then, the spraying assembly 100 may be turned upside down while exerting a pressure onto the reservoir 102 so as to bias the reservoir 102 and the lid 112 towards the spray gun 106. In this configuration, the spraying assembly 100 may be used to spray the liquid onto the surface. Afterwards, the spraying assembly 100 is once again turned upside down and the reservoir 112 may be easily removed from the spray gun 106.

It should be noted that these operations may be performed relatively fast and relatively easily even by relatively inexperienced users. If required, the lid 112 is then removed from the reservoir peripheral wall 110 and the colour of the paint contained within the reservoir 102 is changed by adding paint components in a conventional manner.

Such testing may therefore be performed many times in a relatively short amount of time to ensure that the colour of the paint to be sprayed matches the colour of the paint already present on the surface. When it is desired that a larger quantity of paint be sprayed, the reservoir attachment 136 is secured to the spray gun 106 and is used to attach the reservoir 102 to the spray gun 106 so that the spray gun 106 may be operated with only one hand.

The tube 104 remains secured to the venting member 126 when the spray gun 106 and the reservoir 102 are separated from each other. This may be desirable in cases wherein the liquid is to be kept in the reservoir 102 for some time after being used for possibly being re-used later. In this case, some liquid may dry inside the venting tube 104 and therefore block the venting tube 104. In the embodiment of the invention shown in FIG. 4, the venting tube 104 may then be replaced each time the reservoir 102 is used, which prevents such problems.

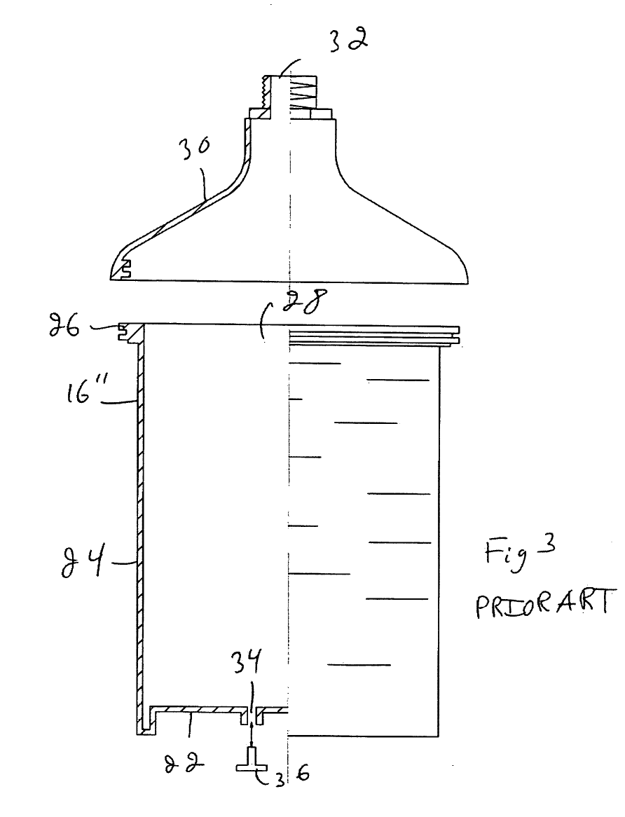

FIGS. 4 and 5 illustrate different configurations of the venting tube 104, reservoir lid 112 and reservoir 102. These configurations are only examples of the many configurations that the venting tube 104, reservoir lid 112 and reservoir 102 may take. Therefore, the venting tube 104, reservoir lid 112 and reservoir 102 may have any other suitable configurations without departing from the scope of the invention as defined in the appended claims. In FIGS. 3, 4 and 5, similar components are denoted by the same reference numerals.

FIG. 5 illustrates an alternative venting tube 104 and reservoir lid 112′ configuration. The reservoir lid 112′ shown in FIG. 4 defines a tube receiving aperture 150 extending therethrough. The venting tube 104 extends through the tube receiving aperture 150.

In some embodiments of the invention, the tube receiving aperture 150 defines an aperture peripheral edge 152, the aperture peripheral edge 152 engaging the venting tube 104 so as to form a substantially liquid-proof seal. Therefore, in the embodiment of the invention shown in FIG. 5, the venting member 126 is not required. Therefore, the spraying assembly formed is relatively easily cleaned. In some embodiments of the invention, the tube 104 either extends integrally from the aperture peripheral edge 152, is glued to the aperture peripheral edge 152 or frictionally engages the aperture peripheral edge 152, among other possibilities.

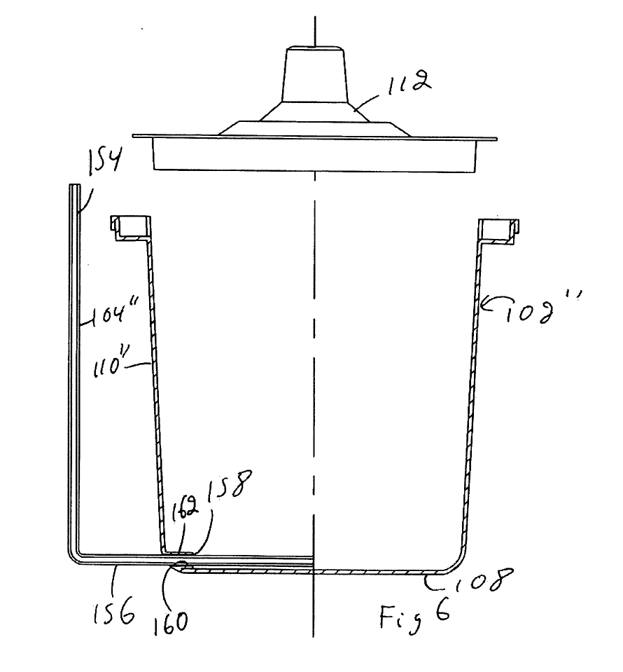

As shown in FIG. 6, in other embodiments of the invention, the reservoir peripheral wall 110″ of an alternative reservoir 102″ defines a tube receiving aperture 158 extending therethrough. The tube receiving aperture 158 defines an aperture peripheral edge 160. A venting tube 104″ extends through the tube receiving aperture 158 and engages the aperture peripheral edge 160 so as to form a substantially liquid-proof seal, substantially similarly to the manner in which the venting tube 104 forms a seal with the tube receiving aperture 150.

For example, the aperture peripheral edge 160 is formed by a substantially cylindrical flange 162 extending substantially radially inwardly into the reservoir from the reservoir peripheral wall 110′.

The venting tube 104″ may many take alternative configurations. For example, the venting tube 104″ is substantially L-shaped. As such, the venting tube 104″ defines a tube first segment 154 and a tube second segment 156 extending substantially perpendicularly therefrom. The tube first segment 154 extends substantially perpendicularly to the reservoir end wall 108 outside of the reservoir 102″. The tube second segment extends substantially parallel to the reservoir end wall 108 through the tube receiving aperture 158. In these embodiments of the invention, the tube receiving aperture 158 is located substantially adjacent the tube end wall 108.

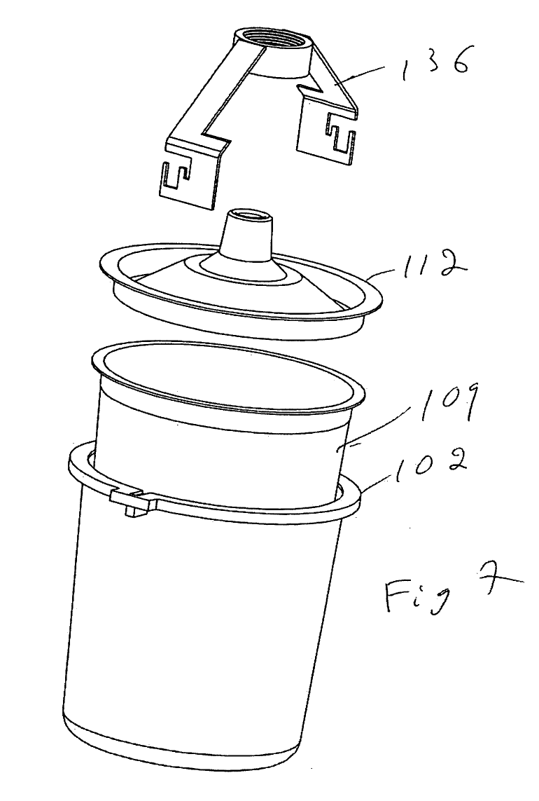

The reservoir attachment 136 is described hereinbelow in further details. Also, many different configurations that the spout 122 and the gun inlet 120 may take are also described. These configurations are given by way of example only and the structures may take any other suitable configuration. Also, the reader skilled in the art will readily appreciate that the structure of the spout 122, the gun inlet 120 and the reservoir attachment 136, as well as the manner in which the reservoir attachment 136 attaches to the reservoir 102 are not necessarily used exclusively with the venting tube 104. In other words, these structures may be used in embodiments of the invention wherein there is no venting tube 104 provided. This is made possible, for example, when the reservoir 102 is not rigid or when the reservoir 102 contains a substantially collapsible liner 109, as shown in FIG. 7. In these embodiments, there is no need to vent the interior or the reservoir 102 and the venting tube 104 may then be omitted.

Referring to FIG. 4, many conventional spray guns 106 include an inlet threaded element 164 provided substantially adjacent their inlet. The inlet threaded element 164 includes externally located inlet threaded element threads 165. In some embodiments of the invention, such a conventional paint gun 106 is used in conjunction with an adaptor 166 to obtain the liquid supply assembly 100. Therefore, the adaptor 166 allows using a reservoir attachment 136 and the reservoir 102 with a conventional paint gun.

The adaptor 166 is substantially cylindrical and defined an adaptor external surface 168 and an adaptor internal surface 169. The adaptor internal surface is located at the periphery of the gun inlet passageway 124.

The adaptor 166 is defines an adaptor first end 170 and a substantially longitudinally opposed adaptor second end 172. Adaptor internal threads (not shown in the drawings) are provided onto the adaptor internal surface 169 substantially adjacent the adaptor first end 170. The adaptor internal threads 174 engage the inlet threaded element threads 165 so as to allow securing the adaptor 166 to the inlet threaded element 164.

The adaptor external surface 168 includes adaptor external threads 176. Also, an attachment collar 178 extends substantially radially outwardly substantially adjacent the adaptor second end 172. Therefore, the attachment collar 178 is formed by a substantially annular flange extending substantially radially outwardly from the adaptor external surface 168. The adaptor external thread 176 extends substantially adjacent the attachment collar 178 onto the adaptor external surface 168. The adaptor external threads 176 allow attaching the reservoir attachment 136 to the adaptor 166.

To that effect, referring to FIG. 5, the reservoir attachment 136 includes a collar 179. The attachment collar 178 is substantially annular and defines internally located collar threads 180. The collar threads 180 are threadable onto the adaptor external threads 178.

The reservoir attachment 136 further includes attachment arms 182 extending substantially radially outwardly from the collar 179. In some embodiments of the invention, the attachment arms 182 also extend substantially longitudinally relatively to the attachment collar 178. For example, the reservoir attachment 136 includes two substantially diametrically opposed attachment arms 182. Attachment reservoir engaging portions 184 extend from the attachment arms 182.

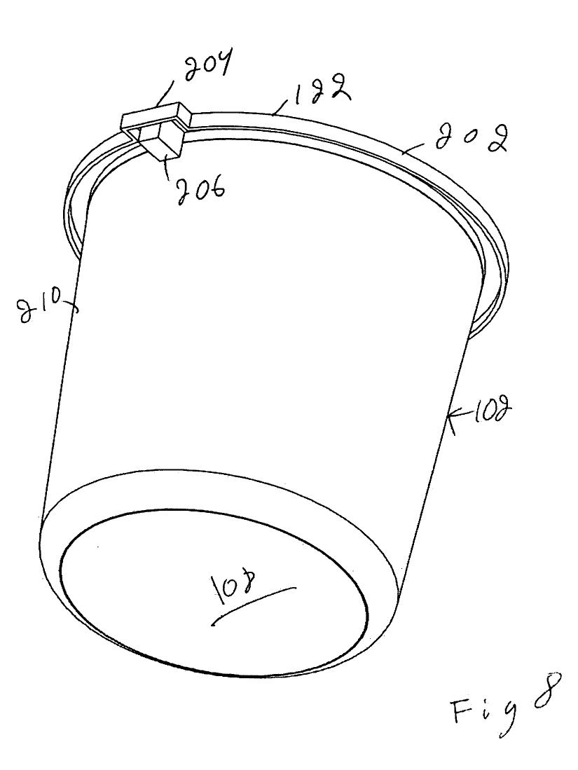

In some embodiments of the invention, the reservoir attachment 136 includes two attachment arms 182. In other embodiments of the invention, the reservoir attachment 136 includes any suitable number of attachment arms. For example, as shown in FIG. 9, in some embodiments of the invention, the attachment arm 182′ has the shape of an arc segment of a substantially conical frustum and includes two attachment reservoir engaging portions 184 extending therefrom. In other embodiments of the invention, the attachment arms 182 may take any other suitable shape.

In some embodiments of the invention, the attachment reservoir engaging portions 184 take the form of engaging portion plates. The engaging portion plates extend substantially longitudinally from the attachment arms 182.

The engaging portion plate defines a plate first side edge 188, a plate second side edge 190 substantially opposed to the plate first side edge, a plate first end 192 and a plate second end 194. The plate first and second side edges 188 and 190 extend between the plate first and second ends 192 and 194. The plate first end 192 is located substantially adjacent the attachment arm 182 to which the plate is attached and the plate second end 194 is located substantially distally relatively to the attachment arm 182.

In some embodiments of the invention, the plate first side edge 188 is located on a leading edge of the engaging portion plate 186, the leading edge being leading when the collar 179 is threaded onto the adaptor external threads 176 such that the collar 179 moves towards the paint gun 106.

A substantially circumferentially extending groove 196 extends from the plate first end 192 substantially adjacent the plate first end 192. First and second notches 198 and 200 extend substantially circumferentially spaced apart from each other from the groove 196. The first and second notches 198 and 200 extend substantially longitudinally from the groove 196 towards the plate second end 194. The groove 196, the first notch 198 and the second notch 200 are configured and sized to engage the reservoir rim, as described in further details hereinbelow.

As shown in FIG. 8, the reservoir 102 includes a reservoir flange 202. The reservoir flange 202 is defined by the reservoir rim 122. The reservoir flange 202 has a substantially annular configuration and a substantially L-shaped cross-section. Therefore, the reservoir rim 122 has a substantially U-shaped cross-section.

The reservoir flange 202 defines attachment portions 204. An attachment portion 204 is provided for engaging each of the engaging portion plates 186. Therefore, the number of engagement protrusions 206 may be equal to the number of engaging portion plates 186.

The attachment portion 204 defines an attachment protrusion 206 extending substantially longitudinally towards the reservoir bottom wall 108. The attachment protrusion 206 is located substantially radially outwardly relatively to container peripheral wall 210. The attachment protrusion 206 is provided for engaging the first notch 198. The second notch 200 is provided for engaging a longitudinally extending outermost segment of the reservoir flange 202.

In use, the collar 179 is threaded onto the adaptor external threads 176 and the adaptor 176 is threaded onto the inlet threaded element 164. The collar 179 is moved substantially longitudinally outwardly away from the spray gun 106 by threading the collar 179 onto the adaptor 176. It should be noted that the adaptor flange 178 prevents the adaptor 176 from being dismounted from the adaptor 176.

Then, the reservoir spout 122 is inserted into the adaptor 166. Afterwards, the collar 179 is threaded onto the adaptor external threads 176 so as to move substantially towards the paint gun 106. As the reservoir attachment 136 is rotated, the groove 196 engages the attachment portion 204.

Then, as the reservoir attachment 136 moves towards the spray gun 102, the attachment protrusion 206 gets inserted into the first notch 198. When the attachment protrusion 206 reaches the first notch distal end, the first notch distal end biases the reservoir 102 towards the spray gun 106 as described hereinabove. To remove the reservoir 102 from the spray gun 106, the above-described operations are performed in reverse.

Therefore, the reservoir attachment 136 allows to relatively easily secure the reservoir 102 to the spray gun 106 while being retrofittable to existing spray guns.

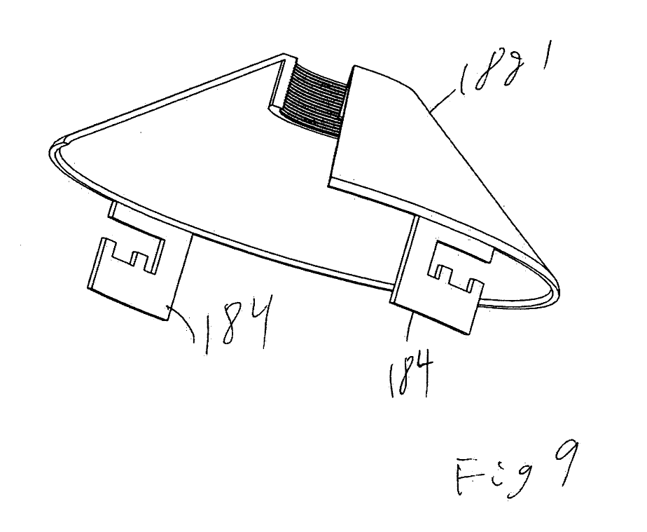

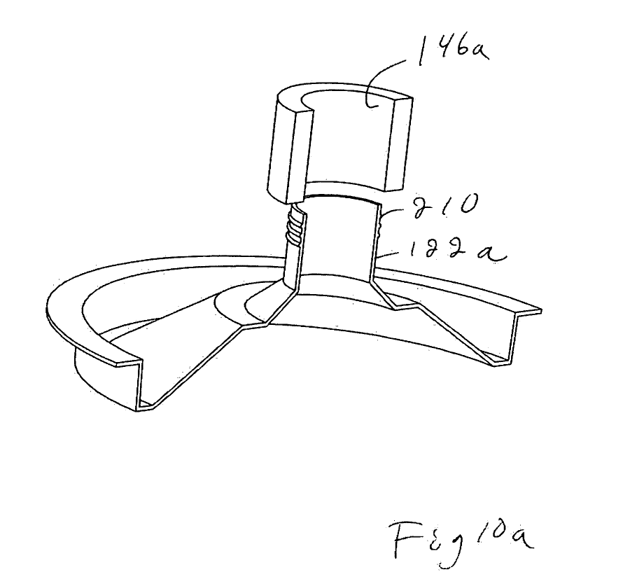

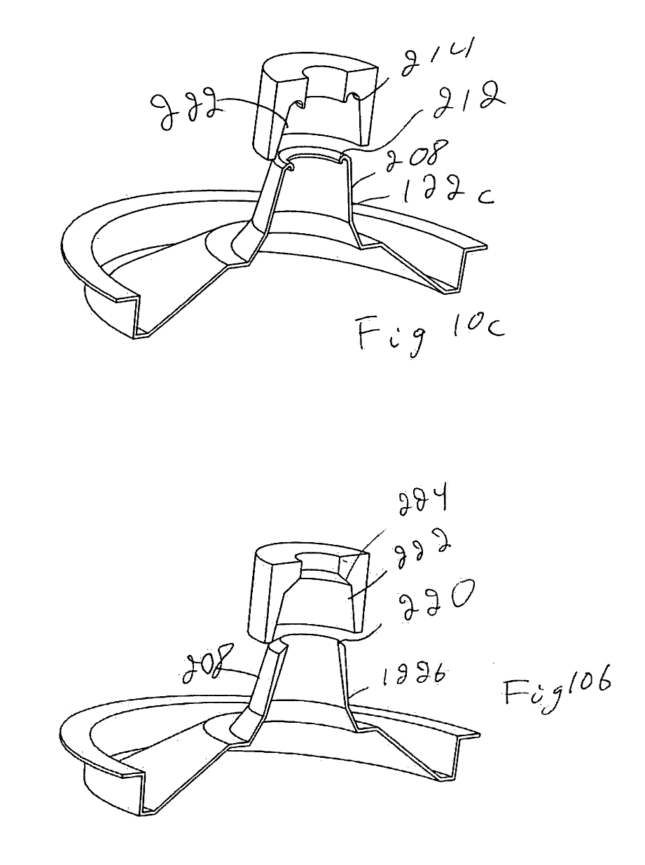

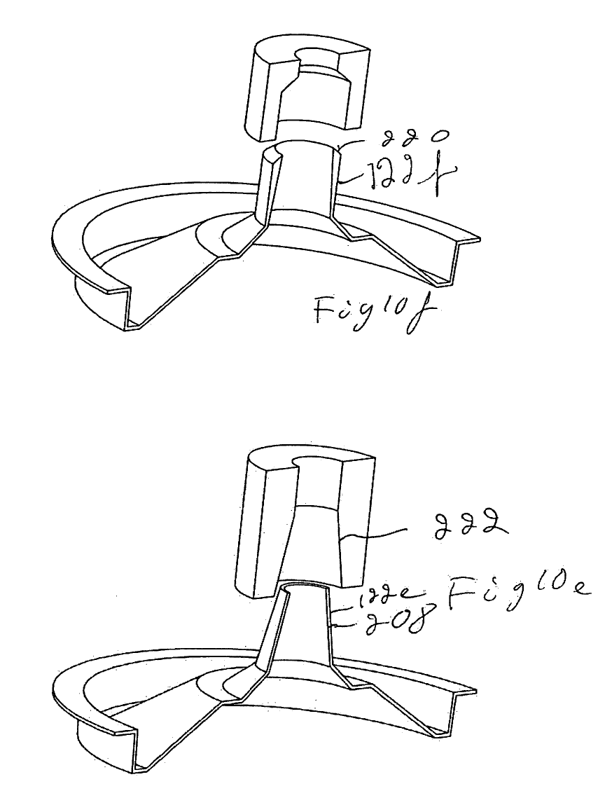

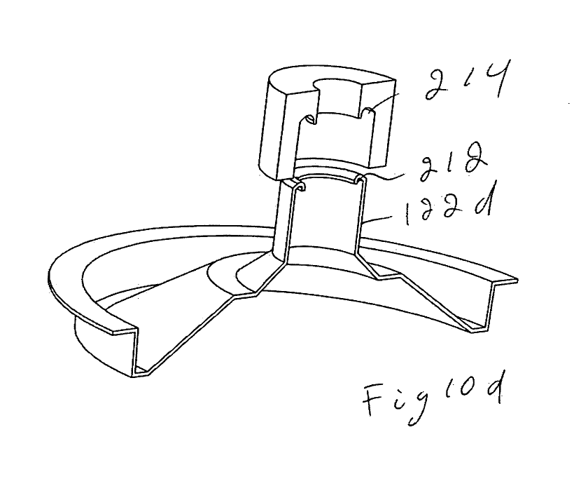

FIGS. 10a to 10e show different manners in which the spout 122 of the lid 112 may be formed. Depending on the exact shape of the spout 112, the internal surface of the spray gun inlet will take different shapes.

For example, as shown in FIG. 10a, in some embodiments of the invention, the reservoir lid includes a lid spout 122a that is substantially cylindrical. Ribs 210 extend substantially radially outwardly from the outer surface of the spout 122a. Therefore, the ribs 210 are substantially annular. One or more ribs may be provided, the ribs being substantially longitudinally spaced apart from each other. In this embodiment of the invention, the gun inlet has a substantially cylindrical gun inlet inner surface 146a. The diameter of the inner surface is such that the ribs 210 substantially frictionally engage the gun inlet inner surface 146a.

Referring to FIG. 10b, in some embodiments of the invention, a lid spout 122b is substantially tapered in a direction leading substantially away from the container end wall 102. For example, the spout 122b includes a first tapered section 208 and a second tapered section 220, the second tapered section 220 being substantially more tapered than the first tapered section 208. Correspondingly, the gun inlet includes two tapered sections 222 and 224 having shapes substantially complementary to the shapes of as the first and second tapered sections 208 and 220 of the spout outlet. In some embodiments of the invention, the two tapered sections 22 and 224 are substantially frusto-conical.

Referring to FIG. 10c, there is shown that instead of having a second tapered section 220, a spout 122c(?) may include a substantially annular lip 212 extending from a substantially frusto-conical tapered section 208. For example, the lip 212 has a substantially U-shaped radial cross-section. The lip 212 is received by a corresponding substantially annular groove 214 located into the gun inlet.

As seen in FIGS. 10d and 10e, some variants may be provided from the different elements shown in FIGS. 10a, 10b and 10c. For example, an alternative lip spout 122d may include a lip 212 formed at a distal end thereof. The spout 122d is substantially cylindrical. In this case, the gun inlet has a substantially cylindrical inner surface and defines the groove 214 for receiving the lip 212.

Referring to 10e, a lid spout 222e may include only one substantially frusto-conical tapered section 218 that is received by a corresponding substantially frusto-conical section of the gun inlet.

Finally, referring to FIG. 10f, a substantially cylindrical 122f may end in a substantially tapered section 220.

In the embodiments shown in FIGS. 10b, 10c, 10d, 10e and 10f, the lid spout is substantially axially sealed to the gun inlet. In other words, it is a substantially longitudinally exerted force that biases the gun inlet 122 towards a spout that provides the seal. In the embodiment of the invention shown in FIG. 10a, the seal is instead provided substantially radially as the ribs 210 are biased towards the gun inlet inner surface.

Although the present invention has been described hereinabove by way of preferred embodiments thereof, it can be modified, without departing from the spirit and nature of the subject invention as defined in the appended claim.

What is claimed is:

1. A spraying assembly for spraying a liquid, said spraying assembly comprising:
a reservoir for containing the liquid, said reservoir defining a reservoir outlet;
a venting tube defining a tube inlet, a tube outlet substantially opposed to said tube inlet and a tube passageway extending therebetween, said tube inlet being positioned within said reservoir; and
a spray gun for spraying the fluid, said spray gun including a gun inlet couplable to said reservoir outlet so as to allow said liquid to flow from said reservoir into said spray gun;
wherein said tube outlet is in fluid communication with the exterior of said reservoir thereby allowing venting said reservoir such as to reduce a vacuum created when the liquid flows out from said reservoir through said reservoir outlet.

2. A liquid spraying assembly as defined in claim 1, wherein
said reservoir includes a reservoir end wall, a reservoir peripheral wall extending therefrom and a reservoir lid extending from said reservoir peripheral wall substantially opposed to said reservoir end wall;
said reservoir outlet is a lid outlet defined in said reservoir lid, said tube extending in a direction leading substantially away from said reservoir end wall such that said tube outlet is positioned further away from said reservoir end wall than said tube inlet.

3. A liquid supply assembly as defined in claim 2, wherein said tube inlet is positioned substantially adjacent said reservoir end wall.

4. A spraying assembly as defined in claim 3, wherein
said reservoir peripheral wall defines a reservoir rim located substantially opposed to said reservoir end wall; and
said tube outlet is positioned further away from said reservoir end wall than said reservoir rim.

5. A spraying assembly as defined in claim 3, wherein said reservoir lid defines a tube receiving aperture extending therethrough, said tube extending through said tube receiving aperture.

6. A spraying assembly as defined in claim 3, wherein
said reservoir peripheral wall defines a tube receiving aperture extending therethrough, said tube receiving aperture defining an aperture peripheral edge; and
said venting tube extends through said tube receiving aperture and engages said aperture peripheral edge so as to form a substantially liquid proof seal.

7. A spraying assembly as defined in claim 6, wherein said venting tube is substantially L-shaped, said venting tube defining a tube first segment and a tube second segment extending substantially perpendicularly therefrom, said tube first segment extending substantially perpendicularly to said reservoir end wall outside of said reservoir and said tube second segment extending substantially parallel to said reservoir end wall through said tube receiving aperture.

8. A spraying assembly as defined in claim 7, wherein said aperture peripheral edge is formed by a substantially cylindrical flange extending substantially radially inwardly into said reservoir from said reservoir peripheral wall.

9. A spraying assembly as defined in claim 3, wherein
said gun inlet defines an inlet passageway for receiving the fluid;
said venting tube includes a tube first segment and a tube second segment;
tube second segment extends partially within said inlet passageway;
said tube first segment extends through said lid outlet;
said tube first and second segment are in fluid communication with each other.

10. A spraying assembly as defined in claim 9, wherein said tube second segment is partially inserted into said tube first segment so as to extend through said tube outlet.

11. A spraying assembly as defined in claim 3, wherein said reservoir peripheral wall defines a reservoir rim located substantially opposed to said reservoir end wall and a reservoir aperture extending thereacross, said reservoir lid being reversibly attachable to said reservoir peripheral wall substantially in register with said reservoir aperture.

12. A spraying assembly as defined in claim 11, further comprising a reservoir attachment, said reservoir attachment being operable between a locked configuration and an unlocked configuration, wherein in said locked configuration, said reservoir attachment secures said reservoir to said spray gun and in said unlocked configuration, said reservoir attachment allows to detach said reservoir from said spray gun.

13. A spraying assembly as defined in claim 12, wherein in said locked configuration, said reservoir attachment biases said reservoir rim and said reservoir lid towards each other.

14. A spraying assembly as defined in claim 12, wherein
said reservoir rim includes a substantially annular and radially outwardly extending rim flange;
said lid includes a substantially annular lid flange located at the periphery thereof, said lid flange abutting against said rim flange when said reservoir lid is attached to said reservoir peripheral wall.

15. A spraying assembly as defined in claim 12, wherein
reservoir lid includes a lid spout, said lid outlet being defined by said lid spout;
said reservoir lid includes a lid rim extending at the periphery thereof, said lid rim being located substantially radially outwardly relatively to said lid spout.

16. A spraying assembly as defined in claim 12, wherein said reservoir lid is deformable between a compressed configuration and an uncompressed configuration, wherein in said compressed configuration, said lid spout is closer to said container end wall than said uncompressed configuration.

17. A spraying assembly as defined in claim 16, wherein said reservoir lid is substantially resiliently deformable between said compressed configuration and said uncompressed configuration.

18. A spraying assembly as defined in claim 3, wherein
said lid spout is substantially tapered in a direction leading substantially away from said reservoir end wall;
said gun inlet defines a gun inlet inner surface, said gun outlet inner surface being tapered in a direction leading substantially away from said reservoir end wall.

19. A spraying assembly as defined in claim 18, wherein said lid spout is insertable into said gun inlet though a substantially longitudinal movement of said lid spout relatively to said gun inlet.

20. A spraying assembly as defined in claim 3, wherein said tube passageway has a passageway diameter of from about 0.2 mm to about 5 mm.
